(19) United States
(12) Patent Application Publication
(10) Pub. No.: US 2021/0206561 A1
(43) Pub. Date: Jul. 8, 2021

(54) PACK FOR PREPARING FOOD OR BEVERAGE PRODUCTS

(71) Applicant: SOCIETE DES PRODUITS NESTLE S.A., Verey (CH)

(72) Inventors: Carlo Magri, Monthey (CH); Amaud Gerbaulet, Oye et Pallet (FR); Silvio Butscher, Chezard-St-Martin (CH); Christophe Sebastien Paul Hyard, Chez Le Bart (CH)

(21) Appl. No.: 17/057,197

(22) PCT Filed: May 6, 2019
(86) PCT No.: PCT/EP2019/061475

§ 371 Date: Nov. 20, 2020

(30) Foreign Application Priority Data
Jun. 1, 2018 (EP) 18175624.8

(51) Int. Cl. B65D 85/804; A47J 31/40

(52) U.S. Cl. CPC B65D 85/8043; B65D 75/5883; A47J 31/407

(57) ABSTRACT

The invention relates to a pack (100) for preparing a food or beverage product from one or more ingredients, the pack comprising an insert (10) through where the food or beverage product is delivered; the pack being configured by at least one flexible sheet folded in such a way to configure at least two distinct and separated volumes, an insert volume (300) where the insert (10) is enclosed, and a product volume (200) where one or more ingredients are stored; the at least one flexible sheet being arranged tightly over the frontal and rear parts of the insert (10) and matching these frontal and rear parts, such that there is a part of flexible sheet material configuring part of the pack (100) arranged below the insert (10). The invention further relates to the use of such a pack for preparing a food or beverage product and to a method for producing a food or beverage product using such a pack.

### FIELD OF THE INVENTION

The present invention relates to a pack for preparing food or beverage products, the pack comprising an insert and a container: a fluid is introduced in the container through the insert in order to prepare the corresponding food or beverage product.

### BACKGROUND OF THE INVENTION

Preparing beverages by introducing a capsule containing a food or beverage ingredient, such as ground coffee or instant coffee, in a beverage dispensing machine and injecting water into the capsule is known in the state of the art: the beverage or food ingredient is typically extracted or dissolved into water to form the beverage or the desired final product, which flows out of the capsule through a suitable outlet.

As such, different capsules have been developed in the past, these capsules being at least differentiated by the nature of the capsule body used for storing the food or the beverage ingredient. Whereas most of the capsules are made of a rigid body or semi-rigid body, typically made though injection moulding or thermoforming, flexible types of packs can be made out of foil materials. Flexible packs have generally the advantage to semi-rigid and rigid capsules that less amount of material is used to pack the product leading to overall less production cost, to lower life cycle impact shown in several life-cycle assessments and to advantages on the part of the user, who will need less available space for storing these packs, as they are more compact.

For example, WO 99/05044 describes a flexible beverage-producing sachet comprising a beverage ingredient in a volume formed by bonding two laminates at their edges, having a base seam into which a conduit of rigid plastics is bonded. An inlet nozzle is provided at the top of the resulting sachet for introducing water that is mixed with the beverage or food ingredient inside the inner volume of the sachet, the beverage produced being then evacuated through a beverage outlet arranged at the bottom of the pack, where closing means are provided, such that the closing means are adapted to open under pressure when pressurized water is introduced into the sachet, allowing the beverage to evacuate through the beverage outlet. However, this configuration presents important drawbacks for the consumer: the opening of the closing means is obtained by increase of pressure inside the sachet. Yet this pressure increase is not recommended for the preparation of some beverages because it creates bubbles at the surface of the beverage, for example this would not be desired for the preparation of tea. Besides, there exists the risk for the user that the packages may not rupture at the desired pressure, and that they would finally open up in an uncontrollable explosion. For this reason the apparatus where the sachet is processed needs to comprise means for totally enclosing the sachet in the machine during beverage preparation in order to avoid risk of damages for the consumer.

Some other flexible sachets are also known in the state of the art, for example as per WO 2011/024103, disclosing a flexible pouch or sachet for preparing a beverage such as coffee, comprising a space where a concentrated dose of the product is stored. The pouch comprises also a rigid part on one of the sides of the pouch, provided with an inlet through which water is inserted into the pouch, a tube element conveying the water towards the opposite part of the pouch, so that the mixing of the water and the ingredient is made, and an outlet through which the product is dispensed. During the preparation of the beverage the beverage outlet is positioned at the top of the pouch. Water is introduced through the inlet and through the tube element until it fills the pouch and overflows through the beverage outlet positioned at the top of the pouch too. Such a pouch is conceived for preparing a beverage by extraction of roast and ground coffee but not by dissolution of instant coffee or other soluble materials. For this reason the pouch comprises a filter at the outlet to prevent insoluble particles from being dispensed with the beverage. An inconvenient of such a pouch is that at the end of the preparation of the beverage and the introduction of water, beverage remains in the pouch which is an issue for the user who cannot properly remove the pouch from the beverage production machine.

In the known flexible pouches or sachets described of the known prior art, neither the water inlet nor the beverage outlet are closed by a membrane, which is not recommended in terms of hygiene and shelf life as it could present problems to the consumer. Moreover, in these known systems, the insert or spout represents a weak point as it is typically made of plastics material such as PE or PP which does not form a barrier for oxygen. By the way the spout is typically sealed with the flexible container or sachet, there are points or paths allowing oxygen to enter the inside of the container, therefore accessing the product stored in it, which represents a weak point from hygienic point of view.

Another document known from the state of the art is for example US 2014/0233871 A1, disclosing a plastic closure device for a tubular bag from a plastic material or from a multi-layered plastic film, in which the plastic closure device comprises at least one lower part with a spout, a spout opening and a flange. The plastic closure device is placed at the desired point onto the shell material (plastic or multi-layered plastic film) of the tubular bag and then welded to the shell material in the region of a flange. The joining of the bag with the spout does not represent an oxygen barrier either, further existing risk of leakage and dirt accumulation in case of not having a proper sealing of the bag and the spout.

Document U.S. Pat. No. 8,205,771 B2 discloses a dispensing system for dispensing a pumpable product from a pouch: the pouch comprises a pouch fitment disposed on an inner or outer surface of the first wall of the pouch, wherein the pouch is positioned in the base fitment-side facing up. Similarly as the arrangement in US 2014/0233871 A1, no oxygen barrier is formed between the flexible container and the fitment assembly, which once again could present problems of leakages and dirt accumulation.

The patent application EP 16155317.7 belonging to the applicant discloses a pack comprising a pouch formed by at least one flexible sheet folded in such a way to configure the container comprising inside one or more ingredients for the preparation of a beverage: the one or more flexible sheets are arranged overwrapping and matching the shape of an insert or fitment through where the fluid is introduced in the inner volume of the container for the preparation of the beverage. Also, the beverage is delivered through the fitment, once prepared. This solution presents some limitations, though: the flexible sheet has to be very precisely overwrapped over the fitment assembly in order to ensure a correct freshness of the product inside the pack during mid and long-time storage: this overwrapping requires, however, a certain complexity and sometimes, when it is not correctly done, there may exist interstices where air may enter and contact the beverage or food product inside, so the product will not be preserved in complete freshness. Moreover, it is important for obtaining a good beverage product that the pack is positioned correctly in the beverage preparation machine, in particular that the fitment (through where fluid is introduced and through where the beverage is dispensed) is adequately positioned in the device for the beverage preparation. Also, it is important that the film overwrapping the lower part of the fitment is properly opened to allow correct beverage dispensing.

Therefore, it is an object of the present invention to provide a solution to the above-described needs, as it will be further explained. The invention also aims at other objects and particularly at the solution of other problems as will appear in the rest of the present description.

### SUMMARY OF THE INVENTION

According to a first aspect, the invention relates to a pack for preparing a food or beverage product from one or more ingredients, the pack comprising an insert through where the food or beverage product is delivered: the pack is configured by at least one flexible sheet folded in such a way to configure at least two distinct and separated volumes, an insert volume where the insert is enclosed, and a product volume where one or more ingredients are stored. In the pack of the invention, the at least one flexible sheet is arranged tightly over the frontal and rear parts of the insert and matching these frontal and rear parts, such that there is a part of flexible sheet material configuring part of the pack arranged below the insert.

Preferably, in the pack of the invention, the insert is configured for introducing a fluid through it and into the volume of the pack to prepare a food or beverage product from one or more ingredients comprised inside that volume.

According to a possible embodiment, the part of flexible sheet material configuring part of the pack arranged below the insert is a sealing: this would be the case of an insert with a lower part being straight, under which a sealing to close the flexible sheet configuring the pack will be placed. According to another possible embodiment, there is an empty volume below the insert.

Typically, the pack of the invention comprises a tear-off line configured in such a way to allow detaching a certain part of the sheet to release at least part of the insert.

In a preferred embodiment of the pack of the invention, the insert comprises at least two parts moveable with respect to each other, providing open or close communication with the inner volume of the pack.

Preferably, the insert comprises an inlet hole through where the fluid is injected, the inlet hole being configured reversibly accessed in the insert.

In the pack of the invention, the at least one flexible sheet is typically provided with side sealing, middle product sealing and a lower sealing to conform the pack.

Preferably, the pack of the invention further comprises at least a recycling tear-off line arranged at a certain height in the pack to allow releasing fully the insert from the rest of the flexible sheet, for recycling.

The pack of the invention can be typically configured as a capsule, as a sachet, as a pouch or the like.

Preferably, the pack of the invention further comprises identification means comprising information on process parameters to produce the food or beverage product, the process parameters being at least one or a combination of the following: temperature of the aqueous fluid injected, pressure of the gaseous fluid injected, total volume of gas and water injected, processing time, etc.

According to a second aspect, the invention relates to the use of a pack as described for preparing a food or beverage product.

Yet according to a third aspect, the invention relates to a method for producing a food or beverage product using a pack as the one described, the method comprising the steps of:
detaching at least part of the flexible film configuring the pack in order to leave apparent at least part of the insert;
placing the pack in a beverage preparation machine by placing the apparent part of the insert in a corresponding receiver in the machine;
injecting a fluid through the insert into the inner volume of the pack for mixing and/or diluting and/or reconstituting the food or beverage product inside and delivering the prepared food or beverage product through the insert or delivering the product inside the pack directly into a preparation container where the food or beverage product will be prepared.

Preferably, in the method according to the invention, the insert is configured by at least two relatively moveable parts, this movement blocking or freeing the communication of the inner volume of the pack with the outside of the pack.

Typically, in the method of the invention, the insert is configured by at least two relatively moveable parts that move with respect to each other to their original position at the end of the preparation of the food or beverage, blocking any communication of the inner volume of the pack with the outside of the pack, to avoid dripping.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIGS. 1a-b show in detail the configuration of the insert in the food or beverage pack of the present invention, in open and closed positions, respectively.

FIG. 2 shows a food or beverage pack according to the prior art, the pack comprising an insert overwrapped by the container.

FIG. 3 shows a food or beverage pack configured according to the present invention.

FIGS. 4a-b show schematically the configuration of a food or beverage pack according to the present invention, comprising a container and an insert.

FIG. 5 shows schematically the tearing-off of a certain part of the pack of the invention, in order to leave free the insert.

### DETAILED DESCRIPTION OF EXEMPLARY EMBODIMENTS

According to the present invention, a pack 100 is disclosed for preparing a food or beverage product, the pack comprising a container 20 and an insert 10. The container 20 comprises at least one ingredient for the preparation of the food or beverage product. Typically, according to a preferred embodiment of the invention, the preparation of the product is made by introducing a fluid through the insert 10, typically water and/or air, so the ingredient is mixed and/or diluted and/or reconstituted before being delivered through a dispensing outlet, which is also arranged in the insert 10. According to another embodiment of the invention, the food or beverage product inside the pack can be delivered directly into a container, where it will be further prepared, for example by adding a fluid, so the ingredient or ingredients will be mixed and/or reconstituted and/or diluted. In the first case (first embodiment) the insert is used to inject a fluid inside the volume of the pack so that a beverage or food product is prepared typically from a concentrated product, such as powder. The insert is also used to deliver the product once it has been prepared. In the second case (second embodiment) the insert is used only for delivering a food or beverage product (prepared or not) comprised inside the volume of the pack: the product can be for example a concentrated product (also a powder, for example) that will be delivered in a container by vibration for example of the pack: once in the container, the product can be diluted, mixed or the like with a fluid that will be added to the container, so the beverage or food product will be prepared therein. Another possibility is that the product is already prepared (for example it is a liquid concentrate) that will be delivered into a container from where it will be further diluted (or not) and consumed.

In the rest of the Description, the examples will be given for the case where a fluid is injected through the insert to mix and/or reconstitute and/or dilute a product inside the pack, though the second embodiment (insert only used to deliver the content of the pack) are also covered within the scope of the present invention.

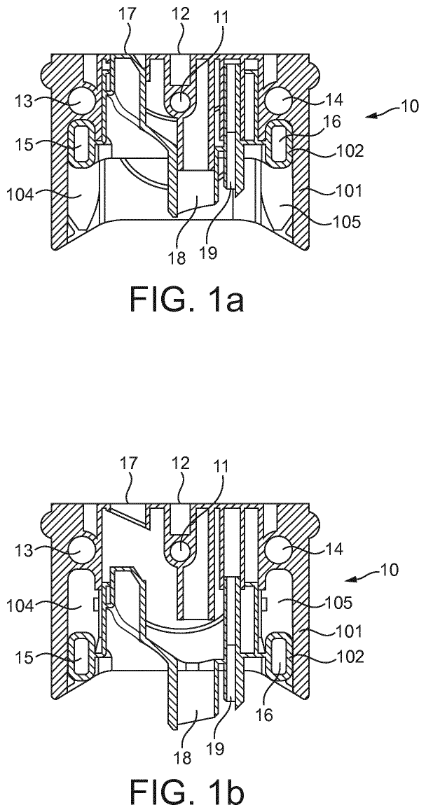

FIGS. 1a and 1b show in detail the configuration of the insert 10 in the pack 100 of the invention: FIG. 1a shows the configuration where the outlet is closed and FIG. 1b shows the configuration with the outlet open for delivering a beverage or food product. The insert 10 of the invention typically comprises two parts, 101 and 102, moveable with respect to each other, preferably by linear displacement. The part 101 is a fixed insert part, which is fixed to the beverage preparation device, and the part 102 is a moveable insert part, moveable with respect to the part 101. The fixed insert part 101 is positioned in the beverage preparation device by means of positioning holes 13 and 14. The beverage preparation device connects with the moveable insert part 102 through displacing holes 15, 16, displacing the insert part 102 linearly downwards by the linear paths 104, 105.

In FIG. 1a, the moveable insert part 102 has not been displaced with respect to the fixed insert part 101, and the inner outlet 17 is closed by the positioning of the moveable insert part 102, blocking said outlet 17, so no beverage can be dispensed through the beverage outlet 18. A fluid, typically water, is injected through the inlet hole 12 typically by a water or fluid needle that is then conveyed through a small injection hole 11 into the inner volume of the container 20, in order to mix and reconstitute the beverage or food product inside. When the beverage has been prepared, the device displaces the moveable insert part 102 with respect to the fixed insert part 101, as shown in FIG. 1b: the beverage prepared inside the container 20 can exit the inner volume through the inner outlet 17 (now not blocked, as the moveable insert part 102 has displaced) and from there go into the beverage outlet 18 and then be dispensed. Also, an air conduct 19 is provided in the moveable insert part 102: no air can go through this conduct 19 in the closed position shown in FIG. 1a: however, when the part 102 has moved with respect to 101, as represented in FIG. 1b, air from the outside of the pack 100 can go into the air conduct 19 so the beverage can be delivered with a certain degree of foaming.

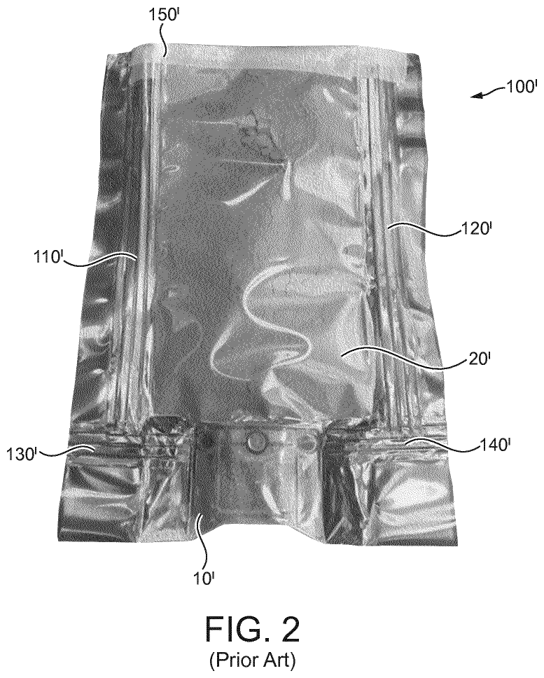

Looking now at FIG. 2, a pack 100′ according to the prior art is shown: this pack 100′ comprises a container 20′ and an insert 10′ that is overwrapped by the flexible sheet configuring the container 20′. This is typically the configuration in European Patent Application EP 16155317.7 belonging to the applicant. As shown in FIG. 2, one flexible sheet of material is folded overwrapping the insert 10′ and conforming to the shape of it, over the whole of its surface, except for the upper part of it which is in contact with the inner volume of the container 20′. Also, the shape of the insert 10′ is made in such a way that a proper overwrapping is achieved without wrinkles. As such, the flexible sheet is arranged tightly sealed over the insert 10′ and the insert 10′ is configured so that the distance which is overwrapped in any of its transversal direction along its longitudinal axis is constant. Both the design of the insert 10′ and the way of doing the overwrapping of the film over it have to be very precisely executed. In order to close tightly the pack 100′, the film is then sealed in several parts to configure the container 20′: as shown in FIG. 2, lateral or side sealing 110′ and 120′ are provided, as well as an upper sealing 150′ and lower sealing 130′, 140′. The film or flexible sheet is also sealed over the frontal and the rear sides of the insert 10′. Therefore, the injection means (fluid needle) pierce the film when connecting with the inlet hole.

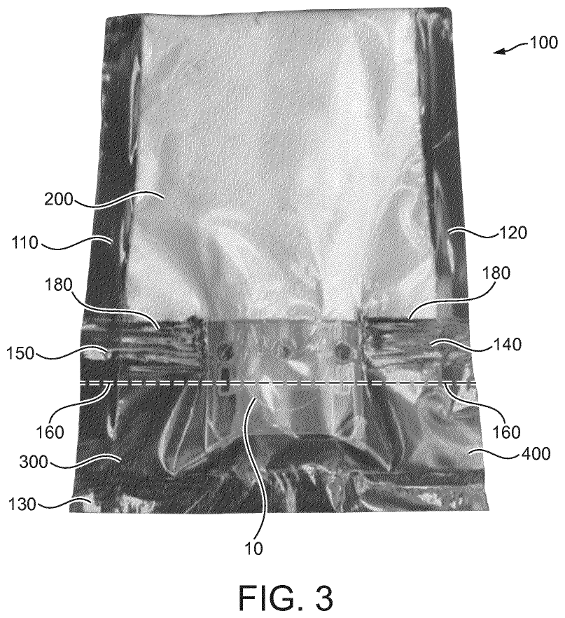

A pack 100 according to the present invention is represented in FIG. 3: the container 20 is configured by a flexible sheet or film overwrapping inside its volume the insert 10. In fact, there are two separated volumes configured in the pack 100: a product volume 200, which is the part of the pack 100 where the food or beverage product is arranged, and an insert volume 300, which is the part of the pack 100 where the insert 10 is arranged inside. The film or flexible sheet overwraps the insert 10 but does not have to conform to the shape of it, as it is the case in the prior art, as the insert is isolated and arranged apart in the insert volume 300. The product and the insert are thus arranged separately during storage and long-time storage of the packs. The manufacturing and configuration of the pack of the invention is simpler than in the prior art, without the need to conform to the shape of the insert in order to provide a barrier for the insert. The separation between the two zones or volumes, product volume 200 and insert volume 300, is ensured by the insert 10 and by the middle product sealing 140, 150.

In the pack of the invention, as shown in FIG. 3, there are side sealing 110, 120 provided on at least part of the side height of the pack 100 (on both sides). The sealing is preferably of the thermos-sealing type. Further, middle product sealing 140 and 150 are provided on the two sides of the container 20 from the insert 10 to the side sealing 110, 120 as shown in FIG. 3. A lower sealing 130 closes the insert volume 300, enclosing the insert 10. Furthermore, the pack 100 of the invention, in particular the container 20, further comprises a tear-off line 160, arranged between the middle product sealing 140, 150 and the lower sealing 130. This tear-off line 160 is configured weakened in such a way that a consumer will easily detach the film or flexible sheet part 400 by pulling this part that will follow the tear-off line 160: once the detachable film part 400 is removed from the pack 100, at least part of the insert 10 is released and this allows the correct placing of the insert, and therefore of the pack, in the corresponding beverage preparation machine. This represents a main advantage of the configuration of the pack of the invention: in the prior art configuration (represented in FIG. 2) the lower part of the pack together with the overwrapped insert and its specific shape have to be placed in a beverage preparation machine, and it is important to do that correctly as the parts of the insert 10 need to be moved with respect to each other to inject the fluid and let it be dispensed once the beverage is prepared. Thus, it is clear that a correct positioning of the insert and of the pack in the machine is essential. With the configuration of the present invention, once the insert has been at least partially released from the rest of the film in the pack, the placement of it in the machine (which is specifically designed in shape to receive the said insert) is evident and easy to do, and avoids mistakes of wrong placements which can lead to a wrong actuation of the parts of the insert and thus to incorrect dissolutions. The tear-off line 160 can be configured in different ways, but will allow detaching a film part 400 to release at least part of the insert: preferably, the displacing holes 15, 16 will typically be released once the detachable film part 400 is removed, and so will be the linear paths 104, 105. The inlet hole 12 will be covered by the film and will be pierced by the piercing and injecting means (typically a needle) and the positioning holes 13, 14 as they are typically arranged in a similar height to that of the inlet hole, they are also typically covered by the film even when the detachable film part 400 is removed.

By removing a part of the film configuring the container 20 of the pack 100 of the invention, namely the removable part 400, at least part of the insert 10 is left free, which allows correctly placing the pack in the corresponding beverage preparation device and also properly accessing the insert 10 and moving the two parts of it 101, 102 with respect to each other in order to prepare the beverage and dispense it. While the pack 100 is not in use, the food or beverage product contained in the product volume 200 remains tight and correctly preserved. Moreover, as the insert 10 is covered by film (is overwrapped) in the insert volume 300, it is also hygienically preserved. Only when the pack is going to be used, the consumer will tear-off the detachable part 400, releasing at least part of this insert 10: therefore, the consumer will be able to correctly place the pack (by means of placing the insert 10 in the corresponding receiving cavity of the beverage preparation device) in the device for its use. It is essential that the pack 100 is correctly placed for the operation needed on the insert 10 (on the operation of the two parts of the insert) and also the pack should remain essentially vertically arranged during the beverage preparation, for correct injection of the fluid, dissolution of the product inside the volume 200 and dispensing of the food or beverage prepared.

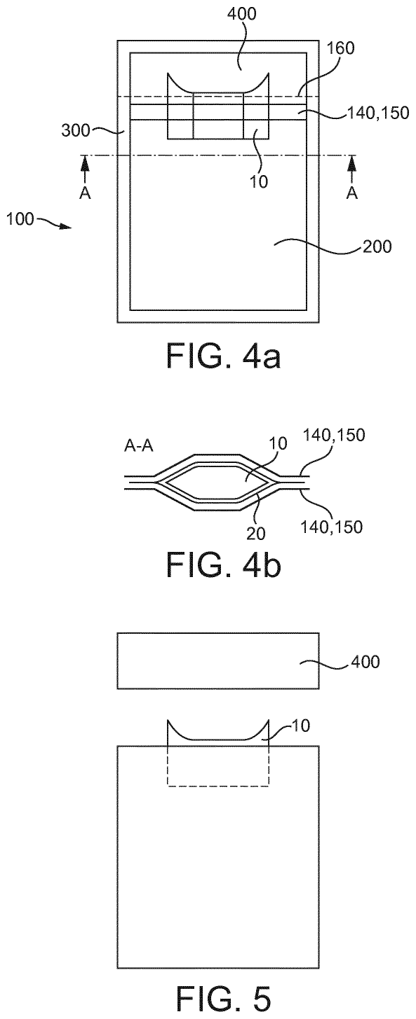

FIG. 4a shows schematically the configuration of the pack 100 according to a possible preferred embodiment of the invention. The pack is represented with the insert 10 in the upper part of it just for showing the configuration of the insert: however, it should be understood that the insert 10 is arranged on the lower part of the pack 10 when the pack is located in the beverage preparation device and the food or beverage is prepared and is dispensed. FIG. 4b shows the cut A-A of FIG. 4b. Finally, FIG. 5 shows the pack 100 when the detachable film part 400 has been detached and removed from the rest of the pack 100, so at least part of the insert 10 has been released and the pack is ready to be placed in a beverage preparation device (as explained before, with the insert arranged on the lower part of the pack, so rotated 180° in vertical from the position in FIG. 5.

Additionally, and optionally, the pack of the invention (as shown in FIG. 4a) can further comprise a recycling tear-off line 180: the purpose of this extra tear-off line is to detach, once the beverage has been prepared and has been fully dispensed, the flexible film parts and the insert 10. Typically, the flexible film parts will be made of a different material than that of the insert 10, so the insert can be recycled separately from the rest of the pack material.

With the pack configuration of the present invention, product freshness is ensured for the consumer. Moreover, as the pack will be opened (tear open) by the consumer, this provides a tamper proof indication that the pouch is in good condition and that it has not been previously manipulated: thus, incorrect pack opening issues will are avoided. The pack of the invention ensures the functionality of the insert and protects it against foreign bodies' intrusion that would be the case when the spout would not be overwrapped by the film.

The pack of the invention is smaller in height than the pack with the overwrapped spout in the prior art (FIG. 2), as there is one sealing less, corresponding to the upper sealing 150′ in the pack 100′. The insert 10 is configured simpler in shape than the one 10′ that has to be overwrapped, so the manufacturing is easier and less expensive. Moreover, there is one sealing less, which is the upper sealing 150′.

Preferably, in order to make the pack 100 reversible, the insert 10 comprises an inlet hole 12 that is a through hole or that can be accessed frontally an on its rear side with blind holes, still able to be accessed from both sides of the pack, frontal and rear side. Preferably, the insert 10 is identical on both its front and rear sides.

According to the present invention the food or beverage ingredient of the container can be comprised within the list of: soups, fruit juices, vegetable juices, bouillons, coffee, chocolate, tea, milk or creamer, smoothies, purees, coulis, creams or a combination thereof. The food or beverage ingredient can be a soluble food or beverage ingredient. Preferably the food or beverage ingredient is a soluble food or beverage ingredient selected in the list of:
instant coffee powder, milk powder, cream powder, instant tea powder, cocoa powder, soup powder, fruit powder or mixture of said powders,
a coffee concentrate, a milk concentrate, a syrup, a fruit or vegetable concentrate, a tea concentrate, a fruit or vegetable puree.

The powders can be agglomerated or sintered. The powders or liquid concentrates can be mixed with solid pieces for example for preparing soups with solid or encapsulated pieces. The food or beverage ingredient can also be an infusable food or beverage ingredient like a roast and ground coffee or tea leaves. In that embodiment water extracts the infusable ingredient.

In the present invention fluid covers either any aqueous diluent that can be mixed with a soluble beverage ingredient to prepare a beverage, like water, carbonated water, milk, etc. (preferably, water is the preferred aqueous diluent) or any gaseous fluid such as for example air. When referring to aqueous fluid, water is the preferred fluid; when referring to gaseous fluid, air is the preferred fluid.

The pack 100 of the invention can be configured having any possible shape, such as a pouch (flexible, for example), a sachet, a capsule, or any other possible container shape.

In contrast with most of the systems in the known prior art, where the fluid is introduced from top to bottom, the pack of the invention works injecting water and preferably air from bottom to top at high velocity, which allows optimal turbulences created inside the container and therefore optimal dissolution of the product inside. The air through the injecting means is not introduced at high pressure: the pressure is preferably comprised between 0.1 and 1.5 bar, more preferably between 0.3 and 0.5 bar. According to the invention, optimal turbulences and dissolution are obtained by high velocity, not by high pressure.

Preferably, the aqueous fluid (water) is injected at a pressure higher than 2 bar, more preferably higher than 3 bar, preferably comprised between 2 and 10 bar, more preferably of around 7 bar. The inlet 12 is configured in such a way that the high pressure fluid injected through it by the injecting means is converted into a high velocity jet, which is driven into the container 20. Typically, the diameter of this inlet is comprised between 1 mm and 4 mm, more preferably between 1.5 mm and 3 mm and comprises a yieldably cover over it which can be pierced by the injecting means. With such a configuration, the high pressure fluid injected by the injecting means is conveyed internally towards the injection hole 11, from which it is converted into a high velocity jet of fluid injected inside the container. Typically, this jet of fluid provided in the container has a velocity of at least about 20 m/s, preferably of at least 30 m/s.

The fluid jet and the turbulences created inside the container avoid that the food or beverage product flows through the beverage outlet 18 too rapidly: therefore, the time of agitation of the ingredient together with the fluid inside the container volume is increased.

As described, the inlet in the insert 10 is configured for introducing the fluid under the form of a jet in the inner volume of the container. By jet it is understood a stream of liquid or fluid into the inner volume of the container quickly and with force. Such a configuration is preferably obtained by placing a constriction (that of the jet inlets) in the fluid path in the inlet hole to reduce the size of the section of the inlet hole. Due to the small surface of the injection hole through which the fluid goes into the inner volume of the container, the pressurized fluid creates a jet in the inner volume of the container.

The small surface of the injection hole presents the advantage of avoiding any back flow of fluid from the inner volume of the container into the inlet hole. For the same fluid to be provided through the inlet hole, the surface of the injection hole can vary according to the nature of the food and beverage ingredient inside the container which is to be mixed with the fluid. In particular when the ingredient is difficult to dissolve a smaller injection hole creates a jet with a higher velocity which improves agitation and dissolution of this ingredient in the container.

The insert 10 is preferably rigid and is made of a rigid plastic material, preferably by injection moulding. Typically, this plastic material can be selected from the following: polypropylene, polyethylene, polyethylene terephthalate and polylactic acid. Also according to a less preferred embodiment the insert 10 can be made of a metal like aluminium or tin-plate.

Different sizes of the pack 100 can be used in a same beverage preparation machine adapted to store different quantities of ingredients: typically, it is the configuration of the insert 10 as to external shape and piercing requirements of the inlet hole what determines the machine to use; however, the size of the containers, when extending vertically, does not determine or limit the machine. As a consequence, it becomes possible to produce different products, such as for example a cup of espresso coffee or a bowl of soup, with the same machine. The external design of the insert 10 will remain unchanged independently on the product targeted; however, the internal design of the insert 10, in particular as to the diameter of the injection hole will differ as a function of the ingredient to be processed and therefore as a function of the food or beverage product targeted. The main idea is that the interface of the insert with respect to the machine remains unchanged. Also, other parameters such as the flow rate of fluid injected and/or the temperature of the fluid injected and/or the total volume of fluid injected, will be modified as a function of the ingredient to be processed and therefore as a function of the food or beverage product targeted.

The pack 100 can also comprise an excrescence enabling the handling of the pack by the user or consumer: this has not been shown in the Figures attached, though.

According to the invention, either the insert 10 and/or the container 20 preferably comprise identification means with the information for fluid or fluids supplied in the inner volume of the container 20 from the inlet hole. Such identification means can comprise any kind of recognition means such as, for example, mechanical codes, optical codes, RFID tags, bar codes, magnetic codes, detection holes or the like.

The identification means also comprise the information on process parameters to produce the food or beverage product. The process parameters are at least one or a combination of the following: temperature of the aqueous fluid injected, pressure of the gaseous fluid injected, total volume of gas and water injected, processing time, etc.

Preferably, as shown in the Figures attached, the pack 100 of the invention presents a plane shape oriented along a plane essentially vertically oriented during beverage production and the injection hole orientates the jet of aqueous and/or gaseous fluid in a direction comprised in said plane. The fluid jets introduced from the bottom into the container develop into circular and spiral movements creating turbulences, frictions and high contact surfaces between the fluid molecules and the ingredient particles. In average the fluid molecules have several turns within the container until they leave it together with the beverage or food product once mixed.

According to the invention, the container is arranged essentially vertically during the production and dispensing of the food or beverage product, and the insert 10 is arranged in such a way that the water and/or air coming through the inlet hole is supplied into the container in an upward direction.

According to the present invention, the aqueous fluid, typically water, can be supplied into the container 20 at any temperature, cold, ambient or hot, depending on the type of food or beverage product targeted.

According to a preferred embodiment of the invention, typically a flexible sheet is folded so as to conform a pouch therefore configuring the container 20 comprising inside the ingredient or ingredients to prepare a food or beverage product out of it. Also preferably, this flexible sheet is further overwrapped around the insert 10 therefore hygienically protecting and isolating it.

Preferably the pack itself is substantially flexible and looks like a pouch or sachet. By flexible, it is meant that the sheets can be bent easily. The resulting pack 100 can be bent also, as being soft and can be deformed contrary to rigid containers. The flexible sheet material can be plastic laminates, metallized foil or alufoil or fibre base material, or a mix of these, further possibly being coated. According to the invention the two flexible water impermeable sheets can be formed of one single flexible water impermeable sheet folded in half and joined at its free edges.

According to a second aspect, the invention further refers to a method for preparing a food or beverage product using a pack 100 as previously described. The method comprises:
the consumer tears off by the tear-off line 160 the detachable film part 400, detaching said part 400 from the pack 100 and leaving at least part of the insert 10 free;
the consumer inserts the pack 100 in a beverage preparation machine, correctly placing the apparent part of the insert 10 in the machine, in a place configured to receive the insert;
the beverage preparation machine connects with the insert 10 by means of:

positioning holes 13, 14; displacing holes 15, 16; inlet hole 12;
the machine places vertically and in a substantially planar surface the pack 100, fixing the pack by the positioning holes 13, 14;
the needle (piercing and injection means) of the machine pierces the film over the inlet hole 12 and injects a fluid at pressure, that will create a fluid jet at high velocity through the injection hole 11, into the inner volume of the pack 100: the jet of fluid mixes and/or dilutes and/or reconstitutes the food or beverage product inside the volume of the pack; the inner outlet 17 is blocked by the position of the moveable insert part 102, that has not been moved yet, so the beverage outlet 18 remains closed while the beverage is prepared;
the beverage preparation machine also connects with the insert 10 through the displacing holes 15, 16: once the food or beverage product has been prepared (correctly mixed and/or diluted and/or reconstituted), the moveable insert part 102 displaces with respect to the fixed insert part 101 through the linear paths 104, 105 and the beverage outlet 18 is open so the beverage prepared can be delivered into a cup or the like;
once the beverage has been fully delivered, the process stops in the preparation machine and the moveable insert part 102 goes back to its original position, thus closing the inner outlet 17: therefore, the consumer can take out the used pack 100 from the machine without any risk of dripping;
optionally, when the pack 100 is provided with a recycling tear-off line 180, the consumer can detach the insert 100 from the rest of the container (film) in order to separate both for a proper recycling.

The method of the invention allows to obtain a proper dissolution of the product inside the pack, and this is achieved by creating strong turbulences that will well mix and dissolve the product before it is delivered. Preferably, pressurized water will be injected into the container 20. The configuration of the insert 10 also allows the introduction of air in the volume of the container 20 and/or together with the fluid injected in order to help achieving the turbulence, hence the dissolution, and also in order to create a foamed beverage or food product. Optimal turbulences help making a good dissolution, also improve foam creation and maintain under control the flow time of the product in cup.

Although the present invention has been described with reference to preferred embodiments thereof, many modifications and alternations may be made by a person having ordinary skill in the art without departing from the scope of this invention which is defined by the appended claims.

1. Pack for preparing a food or beverage product from one or more ingredients, the pack comprising an insert through where the food or beverage product is delivered;
the pack being configured by at least one flexible sheet folded in such a way to configure at least two distinct and separated volumes, an insert volume where the insert is enclosed, and a product volume where one or more ingredients are stored; and
the at least one flexible sheet is arranged tightly over the frontal and rear parts of the insert and matching these frontal and rear parts, such that there is a part of flexible sheet material configuring part of the pack arranged below the insert.

2. Pack according to claim 1 wherein the insert is configured for introducing a fluid through it and into the volume of the pack to prepare a food or beverage product from one or more ingredients comprised inside that volume.

3. Pack according to claim 1 wherein the part of flexible sheet material configuring part of the pack arranged below the insert is a sealing.

4. Pack according to claim 1 wherein there is an empty volume below the insert.

5. Pack according to claim 1 comprising a tear-off line configured in such a way to allow detaching a certain part of the sheet to release at least part of the insert.

6. Pack according to claim 1 wherein the insert comprises at least two parts moveable with respect to each other, providing open or close communication with the inner volume of the pack.

7. Pack according to claim 1 wherein the insert comprises an inlet hole through where the fluid is injected, the inlet hole configured reversibly accessed in the insert.

8. Pack according to claim 1 wherein the at least one flexible sheet is provided with side sealing, middle product sealing and a lower sealing to conform the pack.

9. Pack according to claim 1 further comprising at least a recycling tear-off line arranged at a certain height in the pack to allow releasing fully the insert from the rest of the flexible sheet.

10. Pack according to claim 1 configured as a capsule, as a sachet, as a pouch or the like.

11. Pack according to claim 1 further comprising an identification member comprising information on process parameters to produce the food or beverage product.

12. (canceled)

13. Method for producing a food or beverage product using a pack comprising an insert through where the food or beverage product is delivered, the pack being configured by at least one flexible sheet folded in such a way to configure at least two distinct and separated volumes, an insert volume where the insert is enclosed, and a product volume where one or more ingredients are stored, and the at least one flexible sheet is arranged tightly over the frontal and rear parts of the insert and matching these frontal and rear parts, such that there is a part of flexible sheet material configuring part of the pack arranged below the insert, the method comprising the steps of:
detaching at least part of the flexible film configuring the pack in order to leave apparent at least part of the insert;
placing the pack in a beverage preparation machine by placing the apparent part of the insert in a corresponding receiver in the machine; and
injecting a fluid through the insert into the inner volume of the pack for mixing and/or diluting and/or reconstituting the food or beverage product inside and delivering the prepared food or beverage product through the insert or delivering the product inside the pack directly into a preparation container where the food or beverage product will be prepared.

14. Method according to claim 13 wherein the insert is configured by at least two relatively moveable parts, this movement blocking or freeing the communication of the inner volume of the pack with the outside of the pack.

15. Method according to claim 13 wherein the insert is configured by at least two relatively moveable parts that move with respect to each other to their original position at the end of the preparation of the food or beverage, blocking any communication of the inner volume of the pack with the outside of the pack, to avoid dripping.
